(19) United States
(12) Patent Application Publication
(10) Pub. No.: US 2014/0279380 A1
(43) Pub. Date: Sep. 18, 2014

(54) AUTOMATED SEARCHING CREDIT REPORTS TO IDENTIFY POTENTIAL DEFAULTERS

(71) Applicant: Fannie Mae, (unknown)

(72) Inventors: Yekaterina Melnichenko, Washington, DC (US); David Monaco, Washington, DC (US); Michael Bales, Washington, DC (US); Stacey Shifman, Washington, DC (US); Eric Rosenblatt, Derwood, MD (US)

(21) Appl. No.: 13/827,568

(22) Filed: Mar. 14, 2013

(51) Int. Cl. G06Q 40/02

(52) U.S. Cl. CPC G06Q 40/025
USPC 705/38

(57) ABSTRACT

A system comprises a device including a memory with a risk detection application installed thereon, wherein the risk detection application detects strategic defaulters by generating a rule set in response to receiving a search query, the rule set including a plurality of rules that respectively identify strategic default characteristics determined to correspond to a potential strategic default status, each of the plurality of rules having a corresponding weight; accessing a record in a database of loan information; applying the plurality of rules to determine whether the strategic default characteristics are respectively represented in the record; calculating a strategic defaulter score for the record using the corresponding weights for those of the plurality of rules that are determined to be represented in the record; and outputting the strategic defaulter score for the record.

### BACKGROUND

In general, a property owner (e.g., borrower) who timely pays their debts may receive a good credit score. However, despite a good credit score and the ability to pay, a borrower whose mortgage is upside-down (i.e., the money owed is greater than the property value) may voluntarily choose to cease making mortgage payments for a property. This situation may be referred to as a strategic default, and because a strategic default may present a risk in lending, it may be prudent to search for and detect loans that may be at risk of the strategic default.

In addition, a situation may arise where a borrower whose mortgage on a first property is upside-down, utilizes their good credit to purchase an additional property. Further, once the additional property is purchased, the borrower may cease making mortgage payments for the first property. This situation may be referred to as a “buy and bail” default, which is a specific type of strategic default that warrants particular detection.

### BRIEF DESCRIPTION OF THE DRAWINGS

FIG. 1 illustrates a process flow for applying a credit risk detection heuristic;

FIG. 2 illustrates an exemplary computing system in which a risk detection application operates;

FIG. 3 illustrates an exemplary system in which risk detection applications operate;

FIG. 4 illustrates an exemplary interface for submitting search criteria to a risk detection application; and

FIG. 5 illustrates a process flow for identifying “buy and bail” defaulters.

### SUMMARY OF THE INVENTION

A system comprises a device including a memory with a risk detection application installed thereon, wherein the risk detection application detects strategic defaulters by generating rule set in response to receiving a search query, the rule set including a plurality of rules that respectively identify strategic default characteristics determined to correspond to a potential strategic default status, each of the plurality of rules having a corresponding weight; accessing a record in a database of loan information; applying the plurality of rules to determine whether the strategic default characteristics are respectively represented in the record; calculating a strategic defaulter score for the record using the corresponding weights for those of the plurality of rules that are determined to be represented in the record; and outputting the strategic defaulter score for the record.

### DETAILED DESCRIPTION

An exemplary system and method may include a risk detection application comprising that searches for and identifies strategic defaults by evaluating risk in a mortgagor based on the presence of certain criteria.

A strategic default is the decision by a borrower to stop making payments (i.e., to default) on a debt despite having the financial ability to make the payments. A strategic defaulter is a borrower who makes the decision to strategically default.

Further, strategic defaults are generally associated with residential and commercial mortgages, in which the associated property substantially drops in value such that the mortgage (e.g., debt owed) is considerably greater than the associated property value and may be expected to remain so for the foreseeable future. This situation may sometimes be referred to as negative equity, an underwater property, or an upside-down mortgage.

A class of strategic defaults is a “buy and bail” default. The “buy and bail” default is the decision by a borrower to leverage their good credit to purchase a property additional to an underwater property and to then stop making payments (i.e., to default) on the underwater property after the additional purchase is complete, despite having the financial ability to make the payments on all properties.

A risk detection application may generally be software stored in a memory of a computing system that, when executed by the processor of the computing system, receives search criteria, searches data source stored on at least one database based on the search criteria to produce a dataset, evaluates the dataset utilizing credit risk detection heuristics, and outputs a result set including corresponding weights and/or flags indicating the possibility of a strategic default.

For example, FIG. 1 illustrates an exemplary process 100 for identifying strategic defaulters by a risk detection application. In operation, the exemplary process 100 starts by generating 110 a rule set in response to receiving search criteria, applying 120 the rule set to a dataset (e.g., borrower data) to generate corresponding weights for each rule, and outputting 130 a probability for each record (e.g., borrower of the borrower data) based on a combined corresponding weight relative to each record.

For example, when a risk detection application receives search criteria, the risk detection application may search a database and generate 110 a rule set related to the search criteria.

To search a database, the risk detection application may utilize the received search criteria to generate and apply search conditions to structured or unstructured data sources on at least one database. By applying search conditions to the data sources, the risk detection application may search for and retrieve the data sources within the accessed database that meet the search conditions to produce a dataset. Once produced or extracted, the dataset may be further narrowed by applying at least one rule of the rule set to select records relative to strategic defaulting.

Search criteria are inputs received by the risk detection application, such as identification, loan, or credit information particular to borrowers, lenders, mortgages, properties, or any combination thereof. Search criteria may also include a direct search criterion and/or an umbrella search criteria.

Search criteria for loan information may include, for example, servicer, state, unpaid principal balance (UPB), occupancy status, property type, interest rate, loans modified or in trial, income curtailed, property reported as vacant, multiple active loans, months delinquent, etc. Search criteria for credit information may include, for example, credit score, credit report status, current address indicator, deceased indicator, strategic default, “buy and bail”, number of first liens, associated second liens, payments on associated second liens, bankruptcy status, mark-to-market combined loan-to-value, etc. Other search criteria examples include dates, date ranges, addresses, borrower names, lender names, geographic regions, property values, loan values, etc.

A search condition is a filter that when applied to the data sources includes or excludes data that complies with the condition. For instance, with the direct search criterion, a search condition may be identical to the direct search criterion received by the risk detection application; therefore, a borrower name may be received as direct search criterion and then utilized as the search condition, such that dissimilar names may be excluded from search results.

Regarding the umbrella search criteria, a search condition may be one of a set of search conditions associated with the umbrella search criteria. For instance, a “strategic default” search may be received as the umbrella search criteria which in turn would cause multiple search conditions relative to the “strategic default” search to be utilized to search the data sources. For example, the risk detection application may receive an input of a “strategic default” search (e.g., search criteria), and in turn the risk detection application automatically generates the search conditions of a borrower with a credit score above a threshold and a mortgage based on predetermined table that matches the “strategic default” search with these search conditions.

Structured or unstructured data sources may include credit information, borrower information, property address information, reported address information, credit report information, loan information, status information, etc. As further described below, the data sources within the database are available to the risk detection application via at least one connection through which the risk detection application retrieves the loan information and credit information.

A dataset, in general, may be a collection of data sources particular to the search criteria received by the risk detection application. The rick detection application that may present the dataset in any format. Examples of formats may include a list or tabular format, where columns represent variables and rows correspond to a given member of the dataset, and/or marked up character strings, such as an XML file.

To generate 110 a rule set related to the search criteria, the risk detection application may generate, identify, select, and configure credit risk detection heuristics based on the received search criteria. The risk detection application may include or have access to a database that includes credit risk detection heuristics, which may be a suite of models and algorithms that utilize data sources as an input to generate a probability output. For example, credit risk detection heuristics may include Boolean operators, weights, variables, and commands, that may be selected, parsed, identified, or processed via the risk detection application to generate different credit risk detection heuristic compilations that may be applied to the data sources and may comprise a predetermined table, an association algorithm, intelligent selection algorithms, or the like. A predetermined table may be a data structure that matches specific search criteria with different combinations of search conditions. An association algorithm and intelligent selection algorithms are artificial intelligence data structure that matches specific search criteria and search conditions based on self-learning and direct programming. Manual selection is the manipulation of the search criteria and search conditions based on a received input.

For example, the risk detection application may include or have access to at least one of the following sample heuristics:
is the loan 60 or more days delinquent;
is the Mark-to-Market Combined Loan-to-Value 100% or greater;
has the loan been modified;
was the loan current for six months before becoming delinquent;
was a payment made after becoming delinquent;
has the borrower had a major non-mortgage delinquency;
has the borrower had more than one 30 day non-mortgage delinquency;
has the borrower been paying a second on the loan; and
is the revolving utilization <50% or the revolving balance <$5,000.
   In view of these exemplary heuristics, if the risk detection application received a direct search criterion of “delinquency>60 days,” then the risk detection application may select the “is the loan 60 or more days delinquent” rule from the above exemplary heuristics set to generate a rule set for identifying loans that are delinquent for more than 60 days. If the risk detection application received an umbrella search criteria of “strategic defaulter,” then the risk detection application may extract each heuristic from the above exemplary heuristics set to generate a rule set for identifying strategic defaulters (e.g., strategic defaulter rule set).

Next, the risk detection application applies 120 the rule set to the dataset to generate corresponding weights and/or weighted flags for each rule. Corresponding weights are indicators, such as a product of a calculation, configured to serve as a quick and intuitive representation of an importance of an outcome of an applied rule of the rule set. Flags are indicators, such as a metadata inserts, raw code, text, pictograms, symbols, or the like, configured to serve as a quick and intuitive representation of the outcome of an applied rule of the rule set. For example, when the dataset is in a tabular format, each rule of the generated rule set is applied to an appropriate field of each member. When the dataset is in an XML format, each rule of the generated rule set is applied to an appropriate string.

Next, the risk detection application continues by outputting 130 a probability for each record of the dataset data based on a combined weight relative to that record. For example, the risk detection application may output a probability that a borrower is a strategic defaulted by calculating a combined weight flags for each borrower based on the flags generated by a strategic defaulter rule set. As further discussed below, a result set may also be outputted in a format viewable on a display or as raw data ready for further processing by the risk detection application.

Then, the exemplary process 100 ends.

FIG. 2 illustrates an exemplary computing system 205 having a central processing unit (CPU) 206 and a memory 207 on which a risk detection application 210 comprising an application module 212, a risk detection module 214, and an interface module 216 (which generates user interfaces 217) and database 220 (which manages data sources 221) are stored. The computing system 205 may take many different forms and include multiple and/or alternate components and facilities, e.g., as illustrated in FIG. 3 further described below. While an exemplary computing system 205 is shown in FIG. 2, the exemplary components illustrated in FIG. 2 are not intended to be limiting. Indeed, additional or alternative components and/or implementations may be used.

In general, computing systems and/or devices, such as exemplary computing system 205, may employ any of a number of computer operating systems, including, but by no means limited to, versions and/or varieties of the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OS X and iOS operating systems distributed by Apple Inc. of Cupertino, Calif., the BlackBerry OS distributed by Research In Motion of Waterloo, Canada, and the Android operating system developed by the Open Handset Alliance. Examples of computing devices include, without limitation, a computer workstation, a server, a desktop, notebook, laptop, or handheld computer, or some other computing system and/or device.

Computing systems and/or devices generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, Visual Basic, Java Script, Perl, etc.

In general, a processor or a microprocessor (e.g., CPU 206) receives instructions from a memory (e.g., memory 207) and executes these instructions, thereby performing one or more processes, including one or more of the processes described herein. Such instructions and other data may be stored and transmitted using a variety of computer-readable media. The CPU 206 may also include processes comprised from any hardware, software, or combination of hardware or software that carries out instructions of a computer programs by performing logical and arithmetical calculations, such as adding or subtracting two or more numbers, comparing numbers, or jumping to a different part of the instructions. For example, the CPU 206 may be any one of, but not limited to single, dual, triple, or quad core processors (on one single chip), graphics processing units, visual processing units, and virtual processors.

The memory 207 may be, in general, may be any computer-readable medium (also referred to as a processor-readable medium) that may include any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

The risk detection application 210 may be software stored in the memory 207 of the computing system 205 that, when executed by the CPU 206 of the computing system 205, may receive search criteria via the application module 212 and/or the interface module 216; generate via the risk detection module 214 search conditions based on the search criteria; access via the application module 212 data sources 221 stored on a database 220; search data sources 221 stored on the database 220 via the risk detection module 214 based on the search conditions; generate via the risk detection module 214 a dataset based on the search conditions; generate via the risk detection module 214 credit risk detection heuristics based on the search criteria; evaluate the dataset utilizing credit risk detection heuristics generated via the risk detection module 214; and output a probability via the application module 212 and/or the interface module 216.

In addition, although FIG. 2 illustrates modular examples of the risk detection application 210, where the modules 212, 214, and 216 may be software that when executed by the CPU 206 provides the operations described herein, the risk detection application 210 and its modules 212, 214, and 216 may also be provided as hardware or firmware, or combinations of software, hardware and/or firmware. Additionally, although one example of the modularization of the risk detection application 210 is illustrated and described, it should be understood that the operations thereof may be provided by fewer, greater, differently named, or differently located modules.

The application module 212 may include program code configured to facilitate communication between the modules of the risk detection application 210 and hardware/software components external to the risk detection application 210. For instance, the application module 212 may include program code configured to communicate directly with other applications, modules, models, devices, and other sources through both physical and virtual interfaces. That is, the application module 212 may include program code and specifications for routines, data structures, object classes, and variables that package and present data received from a user via the user interface 217 generated by the interface module 212 for transfer over a network a network or through a connection, as further described below. For example, the application module 212 may include program code for receiving over a network or through a connection search criteria (e.g., in support of generating 105 search conditions) and accessing 110 a database 220 based on the generated search conditions.

The risk detection module 214 may include program code configured to generate search conditions based on the search criteria; access, search, and retrieve data sources 221 stored on the database 220 based on the generated search conditions; generate a dataset based on the search conditions; evaluate the dataset by generating and utilizing credit risk detection heuristics; and output a result set including corresponding weights and/or flags.

For instance, the risk detection module 214 may include program code configured to respond to receiving search criteria by generating 105 search conditions. For example, the risk detection module 214 may include program code configured to receive direct or umbrella search criteria and generate search conditions.

Further, the risk detection module 214 may include program code for performing searches of the accessed database 220 based on the generated search conditions, the results of which (e.g., the retrieved loan information and credit information) are utilized by the risk detection module 214 to produce a dataset (e.g., a dataset in a format appropriate for evaluation by the risk detection application).

The risk detection module 214 may include program code configured to evaluate the dataset by generating and utilizing credit risk detection heuristics based on the received search criteria from a rule set.

For example, the risk detection module 214 may include (or have access via the application module 212 to) credit risk detection heuristics, as described above. The risk detection module 214, in response to receiving the search criteria, may select from the credit risk detection heuristics rules related or assigned to the search criteria and compile the selected rules as a rule set. The rule set may then be applied to the dataset, so that each rule in the rule set may be applied to the dataset and corresponding weights indicating the importance of and/or flags indicating the result of each rule may be outputted.

One example of compiling a rule set in response to receiving “strategic default” as search criteria and applying the “strategic default” rule set to a dataset of borrowers by the risk detection module 214 is as follows. Particularly, the following is a compiled rule set for an exemplary “strategic default” rule set:
Loan is 60 or more days delinquent
Mark-to-Market Combined LTV is 100% or greater
Loan has been modified
Loan was current for six months before becoming delinquent
A payment was made after becoming delinquent
Borrower has a major non-mortgage delinquency
Borrower has more than one 30 day non-mortgage delinquency
Borrower is paying a second on the FNMA loan
Revolving Utilization <50% or Revolving Balance <$5,000

The exemplary “strategic default” rule set above may then be applied to the dataset of borrowers by the risk detection module 214 to produce flags for each compiled rule. The following is a result including flags indicating that a particular borrower of the dataset may be a strategic defaulter—BORROWER CASE 1:
Loan is 60 or more days delinquent: Yes
Mark-to-Market Combined LTV is 100% or greater: Yes
Loan has been modified: No
Loan was current for six months before becoming delinquent: Yes
A payment was made after becoming delinquent: No
Borrower has a major non-mortgage delinquency: No
Borrower has more than one 30 day non-mortgage delinquency: No
Borrower is paying a second on the FNMA loan: No Seconds
Revolving Utilization <50% or Revolving Balance <$5,000: Yes

The following is a result including flags indicating that a particular borrower of the dataset may not be a strategic defaulter—BORROWER CASE 2:
Loan is 60 or more days delinquent: Yes
Mark-to-Market Combined LTV is 100% or greater: Yes
Loan has been modified: No
Loan was current for six months before becoming delinquent: No
A payment was made after becoming delinquent: Yes
Borrower has a major non-mortgage delinquency: No
Borrower has more than one 30 day non-mortgage delinquency: No
Borrower is paying a second on the FNMA loan: No Seconds
Revolving Utilization <50% or Revolving Balance <$5,000: Yes

In both exemplary cases, flags may be generated on a per rule bases by the risk detection module 214. Next, the result of each borrower or record in the dataset may be characterized by (e.g., weighing each rule and calculating a total weight) a probability calculation, which identifies the likelihood of a strategic defaulter. For instance, a probability calculation may comprise assigning a weight, e.g., based on a scale of 1 to 5, where five is most likely to indicate a strategic default and one is the least likely, and calculating a total probability.

In “BORROWER CASE 1” above, the probability calculation would indicate that this borrower or record has a high probability or presents a high risk of a strategic default (e.g., “BORROWER CASE 1” would receive a 5 rating), since each rule was positively flagged. In “BORROWER CASE 2” above, the probability calculation would indicate that this borrower or record has a low probability or presents a low risk of a strategic default (e.g., “BORROWER CASE 2” would receive a 1 rating), since two rules were negatively flagged and their respective weight drives a low probability. For instance, in BORROWER CASE 2,” a higher weight may be given to the “a payment was made after becoming delinquent” rule because when a borrower makes subsequent payments, it may be indicative of an attempt to meet a loan obligation, which may be contrary to defaulting.

Another example of compiling a rule set is in the case of receiving “buy and bail” as search criteria. In this case, an exemplary “buy and bail” rule set would be flagged as follows—“BUY AND BAIL” CASE:
Loan is 60 or more days delinquent: Yes
Mark-to-Market Combined LTV is 100% or greater: Yes
Loan has been modified: No
Loan was current for six months before becoming delinquent: Yes
A payment was made after becoming delinquent: No
Borrower has a major non-mortgage delinquency: No
Borrower has more than one 30 day non-mortgage delinquency: No
Borrower is paying a second on the FNMA loan: No
Revolving Utilization <50% or Revolving Balance <$5,000: Yes

Note that in the ““BUY AND BAIL” CASE,” the flag for the “Borrower is paying a second on the FNMA loan” rule is different than the flag for the same rule in the “BORROWER CASE 2.” This is because, as described above, although a “buy and bail” default is a class of strategic defaults, the “buy and bail” default requires a second loan and property. Hence, if there are no second loan or property, then it may be less likely that the borrower or record may be a “buy and bail” defaulter and more likely that they are strategic defaulter.

The risk detection module 214 may include program code configured to output a result set including corresponding weights and/or flags based on the evaluation of the dataset. For instance, after the risk detection module 214 has completed the evaluation of the dataset by generating and utilizing a rule set related to the received search criteria, the risk detection module 214 continues by outputting 125 a result set including flags based on the evaluation. The result set may be outputted in a format viewable on a display via the interface module 216 or as raw data ready for further processing by the risk detection application.

The interface module 216 may include program code for generating and managing user interfaces 217 that control and manipulate the risk detection application 210 based on a received user input (e.g., configure credit risk detection heuristics, configure search heuristics, select search criteria, configure update settings, and customize configurations). For instance, the interface module 216 may include program code for generating, presenting, and providing one or more user interfaces 217 (e.g., in a menu, icon, tabular, map, or grid format) in connection with other modules for providing information (e.g., data, notifications, instructions, etc.) and receiving user inputs (e.g., search criteria selections and heuristic configuration adjustments, such as user inputs altering, updating, or changing the conversion, credit risk detection, or search heuristics). For example, the interface module 216 may display user interfaces 217 for user management of the search criteria, as described below in reference to FIG. 3.

Moreover, all user interfaces 217 described herein may be provided as software that when executed by the CPU 206 provides the operations described herein. The user interfaces 217 may also be provided as hardware or firmware, or combinations of software, hardware and/or firmware.

Thus, the risk detection application 210 through its modules enables searching across many parameters (e.g., such as Interest rate, occupancy status etc.) to return certain records, borrowers, or loans of which are at risk of a strategic default (e.g., loans which at least one per property is 60 plus days delinquent). In other words, the risk detection application 210 is an automated system that searches for loans that might be at risk of different strategic default maneuvers, due to the presence of certain criteria, and flagged these loans as risky to assist with foreclosure decisions.

The database 220 may include any type of data or file system (e.g., data sources 221) that operates to support the risk detection application 210. For instance, data sources 221 may include borrower information, property address information, reported address information, credit report information, loan information, status information, etc.

In general, databases, data repositories or other data stores, such as database 220, described herein may include various kinds of mechanisms for storing, providing, accessing, and retrieving various kinds of data, including a hierarchical database, a set of files in a file system, an application database in a proprietary format, a relational database management system (RDBMS), etc. Each such data store may generally be included within a computing system (e.g., computing system 205 or database 320) employing a computer operating system such as one of those mentioned above, and are accessed via a network or connection in any one or more of a variety of manners. A file system (e.g., data sources 221) may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In addition, as indicated in FIG. 2, database 220 includes data sources 221 and may be provided as software stored on the memory 207 of computing system 205. Database 220 may also be provided as hardware or firmware, or combinations of software, hardware and/or firmware. For example, as indicated in FIG. 3, database 320 may be a computing device, as described above, including a CPU 306 and memory 307 that is separate from a computing system 305a.

Further, in some examples, computing system 205 elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

In addition, the computing system 205 may take many different forms and include multiple and/or alternate components and facilities, e.g., as in FIG. 3 further described below. While an exemplary computing system 205 is shown in FIG. 2, the exemplary components illustrated in FIGS. 2-3 are not intended to be limiting. Indeed, additional or alternative components and/or implementations may be used.

FIG. 3 illustrates an exemplary system 300 having multiple computing systems. For instance, the exemplary system 300 may have a computing system 305a that includes a CPU 306a and a memory 307a on which a risk detection application 310a comprising an application module 312 and a risk detection module 314 are stored; a database 320 that includes a CPU 306 and a memory 307 on which data sources 321 are managed and stored; and the computing system 305b comprising a CPU 306b and a memory 307b on which a risk detection application 310b comprising an interface module 316 for generating user interfaces 317.

Further, the computing system 305a via a physical connection 328 may establish a virtual connection 329 to access the database 320 so as to retrieve data sources 321 in support of the risk detection application's 310a operations. The computing system 305a may also via a network 330 and utilizing physical connections 331 and 332 establish a virtual connection 333 to receive search criteria obtained by the risk detection application 310a through user interfaces 317 in support of the risk detection application's 310a operations. Note that the same or equivalent elements as those of the FIG. 2 described above are denoted with similar reference numerals, and will not be described in detail with regard to FIG. 3.

Physical connections 328, 331, and 332 are wired or wireless connections between two endpoints (devices or systems) that carry electrical signals that facilitate virtual connections. For instance, the physical connection 328 may be the wired or wireless connection between computer systems 305a and database 320, and the physical connections 331 and 332 may be the wired or wireless connections between computer systems 305a-b and routers on the edge of a network 330. Further, any of the physical connections 328, 331, and 332 may be comprised of computers and other hardware that respectively connects endpoints as described.

Virtual connections 329 and 333 are the protocol infrastructure that enables communication to and from the risk detection applications 310a-b and the database 320.

Network 330 may be a collection of computers and other hardware to provide infrastructure to carry communications. For instance, the network 330 may be an infrastructure that generally includes edge, distribution, and core devices and provides a path for the exchange of information between different devices and systems (e.g., between the computer systems 305a-b). Further, the network may be any conventional networking technology. For instance, network 330 may, in general, be any packet network (e.g., any of a cellular network, global area network, wireless local area networks, wide area networks, local area networks, or combinations thereof, but may not be limited thereto) that provides the protocol infrastructure to carry communications between the computer systems 305a-b and the risk detection applications 310a-b.

FIG. 4 illustrates an exemplary interface 400 for submitting search criteria to a risk detection application. For example, a user interface 317 generated by the user interface module 316 may take the form of exemplary interface 400, which includes input sections.

Each input section may include a drop down list with selectable items, where each selectable item is connected to a search condition (e.g., direct search criterion) or set of set conditions (e.g., umbrella search criteria). When a selectable item is chosen the corresponding search conditions are access, compiled, and utilized for searching and evaluating the data sources (e.g., data sources 221, 321) available to the risk detection application. Exemplary interface 400 is divided into two categories, “loan info” and “Credit Report Info,” and under these categories, input sections 420, 425 have been identified.

In operation, a computing system 305b may receive a selection through the input section 420 of the exemplary interface 400 as generated by the interface module 316 of the risk detection application 310b, where the selection is a “YES.” This selection may instruct the exemplary system 300 to perform a “Strategic Default” detection.

Similarly, a computing system 305b may receive a selection through the input section 425 of the exemplary interface 400 as generated by the interface module 316 of the risk detection application 310b, where the selection is a “YES.” This selection may instruct the exemplary system 300 to perform a “Buy and Bail” detection. The operation of input section 425 will now be described with connection to FIG. 5.

For example, FIG. 5 illustrates an exemplary process flow 500 for detecting “buy and bail” defaulters. In operation, the exemplary process 500 starts by receiving 505 a selection through a user interface indicating “buy and bail” search criteria; generating 510 a rule set in response to receiving the “buy and bail” search criterion; applying 520 the rule set to a dataset to generate corresponding weights and/or weighted flags for each rule; and outputting 530 a “buy and bail” probability for the dataset based on a combined weight of the corresponding weights or the flags relative to each record.

For example, a risk detection application may receive 505 a selection through a user interface indicating a “buy and bail” search criterion. For instance, a user may utilize a computing system 305b to enter a selection through the input section 425 of the exemplary interface 400 as generated by the interface module 316 of the risk detection application 310b, where the selection is a “YES” and instructs the exemplary system 300 to perform a “buy and bail” search.

After receiving the selection, the risk detection application 310b communicates the selection over a network 330 (e.g., via a virtual connection 333) to the application module 312 of the risk detection application 310a, which in turn utilizes the “buy and bail” search criteria to generate a set of search conditions.

The risk detection module 314 of the risk detection application 310a, in turn, may utilize the received “buy and bail” search criterion to generate 510 a rule set. For example, the risk detection module 314 may select and configure “buy and bail” rule compilation from credit risk detection heuristics based on the received search criteria.

The risk detection module 314 of the risk detection application 310a may also utilize the received “buy and bail” search criteria to generate search conditions and search a database 320. For example, the risk detection application 310a may access an search a database 320 through a virtual connection 329 established by the application module 312 based on the generated search conditions (e.g., search conditions may include the open date of a new mortgage is within three months of the 30 day delinquency month on an existing mortgage or a credit rating above threshold, such as a rating above 500). Based on the search, the risk detection application produces a dataset from the database 320.

Next, the risk detection application 310a continues by applying 520 the rule set to a dataset to generate corresponding weights and/or weighted flags for each rule. For example, the risk detection module 314 of the risk detection application 310a applies the “buy and bail” rule compilation to a dataset to generate corresponding weights and/or weighted flags for each heuristic of the “buy and bail” rule compilation.

Next, the risk detection application 310a continues by outputting 530 a “buy and bail” probability for the dataset based on a combined weight relative to each record. For example, the application module 312 of the risk detection application 310a may output 530 a result set including corresponding weights and/or weighted flags based on the application 520 of the “buy and bail” rule compilation to the dataset. Further, the user interface 317 may be generated by the interface module 316 to so that a user who originally selected the “YES” through the input section 425 of the exemplary interface 400 may view which loans have a probability of default and the measure of that probability.

Next, the process 500 ends.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description or Abstract below, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

1. A method for detecting strategic mortgage loan defaulters, the method comprising:
generating, by a processing unit, a rule set in response to receiving a search query, the rule set including a plurality of rules that respectively identify strategic default characteristics determined to correspond to a potential strategic default status, each of the plurality of rules having a corresponding weight;
accessing a record in a database of loan information;
applying the plurality of rules to determine whether the strategic default characteristics are respectively represented in the record;
calculating a strategic defaulter score for the record using the corresponding weights for those of the plurality of rules that are determined to be represented in the record; and
outputting the strategic defaulter score for the record.

2. The method of claim 1, wherein accessing the record includes identifying within the database of loan information a dataset to be examined based on the search query that includes at least the record and subsequently selecting at least the record from the dataset using at least one of the plurality of rules.

3. The method of claim 1, wherein the record is one of a plurality of records in the database, each of the plurality of records is configured to identify a borrower and associated credit and loan information.

4. The method of claim 1, wherein the plurality of rules in the rule set are configured to detect a borrower initially maintaining a first loan corresponding to a first property and then abandoning payment of the first loan after a second loan is used to obtain a second property.

5. The method of claim 1, wherein the corresponding weights are based on a scale of numbers 1 to 5 and calculating the strategic defaulter score comprises summing the numbers for those of the plurality of rules that are determined to be represented in the record.

6. A computer-readable medium tangibly embodying computer-executable instructions for detecting strategic mortgage loan defaulters, comprising:
generating, by a processing unit, a rule set in response to receiving a search query, the rule set including a plurality of rules that respectively identify strategic default characteristics determined to correspond to a potential strategic default status, each of the plurality of rules having a corresponding weight;
accessing a record in a database of loan information;
applying the plurality of rules to determine whether the strategic default characteristics are respectively represented in the record;
calculating a strategic defaulter score for the record using the corresponding weights for those of the plurality of rules that are determined to be represented in the record; and
outputting the strategic defaulter score for the record.

7. The computer-readable medium of claim 8, wherein accessing the record includes identifying within the database of loan information a dataset to be examined based on the search query that includes at least the record and subsequently selecting at least the record from the dataset using at least one of the plurality of rules.

8. The computer-readable medium of claim 8, wherein the record is one of a plurality of records in the database, each of the plurality of records is configured to identify a borrower and associated credit and loan information.

9. The computer-readable medium of claim 8, wherein the plurality of rules in the rule set are configured to detect a borrower initially maintaining a first loan corresponding to a first property and then abandoning payment of the first loan after a second loan is used to obtain a second property.

10. The computer-readable medium of claim 8, wherein the corresponding weights are based on a scale of numbers 1 to 5 and calculating the strategic defaulter score comprises summing the numbers for those of the plurality of rules that are determined to be represented in the record.

11. A system, comprising:
a device including a memory with a risk detection application installed thereon, wherein the risk detection application configured to:
generate a rule set in response to receiving a search query, the rule set including a plurality of rules that respectively identify strategic default characteristics determined to correspond to a potential strategic default status, each of the plurality of rules having a corresponding weight;
access a record in a database of loan information;
apply the plurality of rules to determine whether the strategic default characteristics are respectively represented in the record;
calculate a strategic defaulter score for the record using the corresponding weights for those of the plurality of rules that are determined to be represented in the record; and
output the strategic defaulter score for the record.

12. The system of claim 11, wherein the risk detection application accesses the record by being configured to identify within the database of loan information a dataset to be examined based on the search query that includes at least the record and to subsequently select at least the record from the dataset using at least one of the plurality of rules.

13. The system of claim 11, wherein the record is one of a plurality of records in the database, each of the plurality of records is configured to identify a borrower and associated credit and loan information.

14. The system of claim 11, wherein the plurality of rules in the rule set are configured to detect a borrower initially maintaining a first loan corresponding to a first property and then abandoning payment of the first loan after a second loan is used to obtain a second property.

15. The system of claim 11, wherein the corresponding weights are based on a scale of numbers 1 to 5 and wherein the risk detection application calculates the strategic defaulter score by being configured to sum the numbers for those of the plurality of rules that are determined to be represented in the record.
